(19) United States
(12) Patent Application Publication
(10) Pub. No.: US 2015/0233420 A1
(43) Pub. Date: Aug. 20, 2015

(54) DEVICE INCLUDING AT LEAST ONE SPHERICAL ROLLER BEARING, WITH A PRE-LOADING UNIT, AND A METHOD FOR APPLYING A PRE-LOAD

(71) Applicants: AKTIEBOLAGET SKF, Göteborg (SE); SKF (CHINA) SALES CO LTD, Baouou (CN)

(72) Inventors: Kjell Bogvad, Gothenburg (SE); Hans-Juergen Liesegang, Schortens (DE); Christian Zang, Nordheim (DE)

(73) Assignees: SKF (CHINA) SALES CO LTD, Baotou (CN); AKTIEBOLAGET SKF, Göteborg (SE)

(21) Appl. No.: 14/407,842

(22) PCT Filed: Jun. 19, 2013
(86) PCT No.: PCT/EP2013/062691

§ 371 Date: Apr. 23, 2015

(30) Foreign Application Priority Data
Jun. 20, 2012 (DE) 10 2012 210 419.4

(51) Int. Cl. F16C 25/08; F16C 33/60; F16C 23/08

(52) U.S. Cl. CPC F16C 25/083; F16C 23/082; F16C 33/60

(57) ABSTRACT

A device includes at least one spherical roller bearing that has at least one split bearing ring, the split bearing ring having first and second parts, the device including at least one preloading unit that is configured to exert a force on at least the first part of the bearing ring and at least one control unit that is configured to change the force. The preloading unit comprises a hydroelastic preloading unit and may include an elastic tube for applying a force against the first part of the bearing ring and a pump for pumping a liquid into the tube.

The invention emanates from a device according to the preamble of claim 1.

A device including at least one spherical roller bearing is known, which spherical roller bearing includes a split bearing ring.

Furthermore, a device including two tapered roller bearings is known which supports a shaft.

For example, a bearing assembly, in particular for a machine tool, is known from DE 101 26 103 A1, including at least two rolling-element bearings for the supporting of a shaft in a housing. The rolling-element bearings are designed for the supporting of axial forces and introduced into the housing positioned in the same direction in tandem arrangement. Each rolling-element bearing is furthermore axially preloadable by at least one clamping device, wherein the clamping devices of the rolling-element bearings are coupled to one another for mutual compensating of the axial forces acting on the rolling-element bearings.

DE 43 33 196 A1 discloses a spindle unit which can compensate for any displacement of the spindle due to thermal expansion and which can adjust the preload on the bearing according to the rotational speed of the spindle.

For example, EP 1 705 392 B1 discloses a double row spherical roller bearing wherein a gap is provided between the two split outer rings and a preload is applied to these split outer rings.

Furthermore, U.S. Pat. No. 3,934,957 discloses a double row spherical roller bearing including a split outer ring. A spring is disposed between a housing surface and an outer ring. A pair of spring elements is disposed between the split outer rings as a damper.

The object of the invention consists in particular of providing a device of the above-mentioned type which is economically manufacturable and long-lasting. The object is inventively achieved by the features of patent claim 1, while advantageous embodiments and further developments of the invention can be derived from the dependent claims.

The invention emanates from a device including at least one spherical roller bearing, which spherical roller bearing includes a split bearing ring.

It is proposed that the device includes at least one preloading unit which is provided to exert a force on at least a first part of the bearing ring. A “split bearing ring” shall be understood in particular to mean a bearing ring which includes at least two separate components, which are preferably configured as rings. A “preloading unit” shall be understood in particular to mean a unit which is provided to exert a force on at least a first part of the bearing ring, wherein the unit is preferably provided to exert a force on a first ring of the bearing ring such that this first ring is pressed, preferably along an axial direction of the spherical roller bearing, against a second ring of the bearing ring. “Provided” shall be understood in particular to mean specifically designed and/or specifically equipped and/or specifically programmed. Using an inventive design, a long-lasting configuration and economical manufacturability of the device can be achieved. In particular it can be achieved that the parts of the split bearing ring are preloaded against one another, so that a bearing play of the spherical roller bearing is prevented in its axial direction. In particular, the preventing of the bearing play effects movements of a shaft, which is connected to an inner ring of the spherical roller bearing, in the axial direction, whereby a lower wear of a drive that is connected to the shaft is achieved. In particular, the preventing of bearing play effects the reducing of dynamic loads on the device. In particular, an economical design is achieved by the shaft that is connected to the inner ring being angularly movable through the spherical roller bearing so that the shaft can be economically supported by a three-point bearing. In particular, the kinematic characteristics of the bearing are barely adversely influenced by the preloading unit.

It is further proposed that the device includes at least one control unit, which is provided for changing the force. A “control unit” shall be understood in particular to mean a unit which is provided for a controlling of a process wherein the unit preferably includes an electronic computing unit, a storage unit, and an operating program stored in the storage unit. An effective adjusting of the force can thereby be achieved.

The preloading unit is preferably configured as a hydroelastic preloading unit. A “hydroelastic” preloading unit shall be understood in particular to mean a preloading unit which is provided to exert the force using an element, such as, in particular, a hose; the element is elastic and fillable with a liquid. A simple and effective construction can thereby be achieved.

Further advantages will become apparent from the following drawing description. An exemplary embodiment of the invention is depicted in the drawings. The drawings, the description, and the claims contain numerous features in combination. The person skilled in the art will also advantageously consider the features individually and combine them into further meaningful combinations.

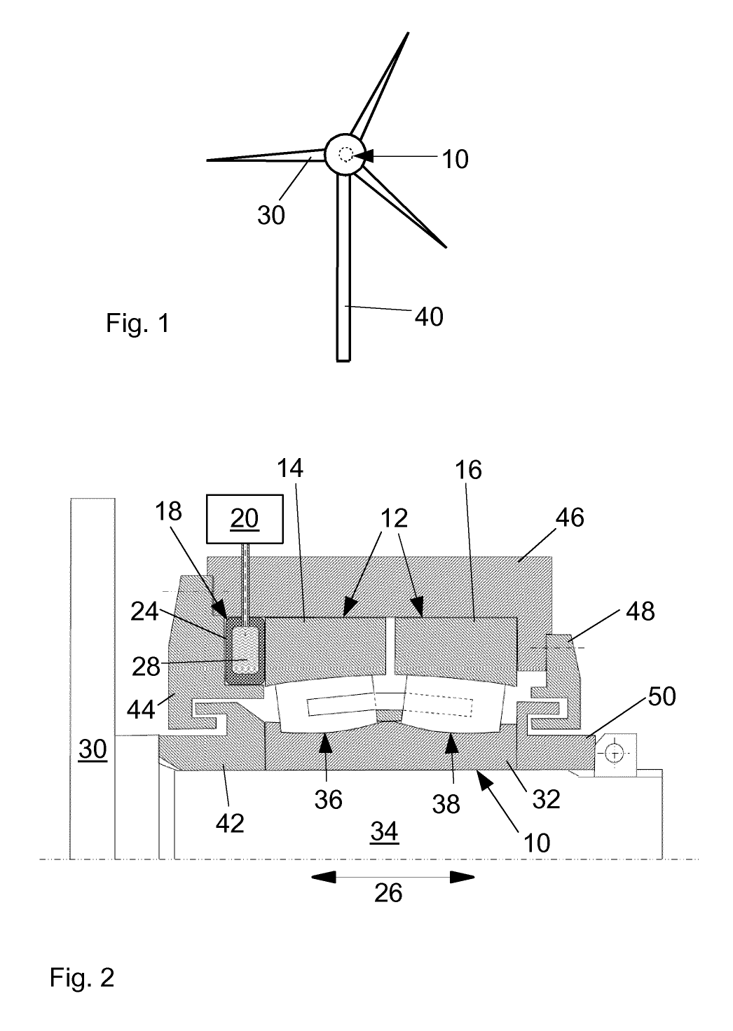

FIG. 1 shows a schematic view of a wind turbine,

FIG. 2 shows a schematic partial section through an inventive device.

FIG. 1 shows a schematic view of a wind turbine, which includes an inventive device (FIG. 2). The device rotatably supports a shaft 34 of the wind turbine, which shaft 34 is attached to a rotor of the wind turbine. For this purpose the device comprises a spherical roller bearing 10, which includes an inner ring 32 and a split bearing ring 12, which is configured as an outer ring. The shaft 34 is connected to the inner ring 32. The split outer ring includes a first part 14 and a second part 16, which are components formed separately from each other. A first row 36 of rolling elements of the spherical roller bearing 10 contacts the inner ring 32 and the first part 14. A second row 38 of rolling elements of the spherical roller bearing 10 contacts the inner ring 32 and the second part 16.

A support unit 40 of the wind turbine supports the weight force of the device and of the rotor and transfers it to the ground. The device includes a holding unit including individual components 42 to 50, which fix the inner ring 32 relative to the support unit 40. The holding unit further contributes to fixing the part 16 relative to the support unit. The holding unit is fixed relative to the support unit 40.

The part 14 is movably supported relative to the inner ring 32. A hydroelastic preloading unit 18 exerts a force on the part 14, which force is oriented parallel to an axial direction 26 of the spherical roller bearing. The preloading unit includes a hose 24, a liquid 28, and a regulating unit 20. The hose abuts on the first part 14 and on the components 44, 46 and is disposed between the first part 14 and the component 44. A partial quantity of the liquid 28 is disposed in the hose. Another partial quantity of the liquid 28 is disposed in the regulating unit 20. The regulating unit 20 includes a storage unit wherein a target value of the pressure of the partial quantity of the liquid 28, which partial quantity is disposed in the hose, is stored. The regulating unit regulates the pressure of the partial quantity of the liquid 28, which partial quantity is disposed in the hose, to the target value. The force that the hose exerts on the part 14 is thereby adjusted to a constant value.

If the pressure of the pressure of the partial quantity in the hose falls due to external influences, the regulating unit ensures that a further quantity of liquid of the liquid 28 is introduced into the hose. For this purpose the regulating unit includes a pump (not depicted). If the pressure of the partial quantity in the hose rises due to external influences, the regulating unit ensures that a quantity of liquid of the liquid 28 is taken out of the hose.

Furthermore, the preloading unit and the regulating unit are configured such that with a sudden axial load of the part 14, while the bearing exhibits a rigid behavior, the partial quantity of the liquid 28, which is located in the hose, can change, so that a damping of the load results.

Due to the regulating unit it can be achieved that despite temperature changes that result in an expanding or shrinking of the shaft, the force remains constant so that a seizing of the bearing is prevented.

The part 14 is free of an axial load except for the force transmitted to the part 14 by the preloading unit.

Alternatively to the regulating unit the device can include a control unit, which can change the pressure of the partial quantity of the liquid, which partial quantity is disposed in the hose.

### REFERENCE NUMBER LIST

10 Spherical roller bearing
12 Bearing ring
14 Part
16 Part
18 Preloading unit
20 Regulating unit
24 Hose
26 Direction
28 Liquid
30 Rotor
32 Inner ring
34 Shaft
36 Row
38 Row
40 Support unit
42 Component
44 Component
46 Component
48 Component

1. A device including at least one spherical roller bearing, the spherical roller bearing having at least one split outer bearing ring, the device comprising:
at least one preloading unit, which is provided to exert a force on at least a first part of the outer bearing ring and at least one control unit, which is provided to change the force, wherein the preloading unit comprises a hydroelastic preloading unit, and
wherein the hydroelastic preloading unit includes a hose that abuts on the first part of the outer bearing ring and wherein a liquid for influencing the force is pumpable into the hose and pumpable out of the hose.

2. (canceled)

3. The device according to claim 1, wherein the device includes at least one regulating unit, which is provided to regulate the force to a predetermined value.

4. (canceled)

5. The device according to claim 1, wherein the device includes a regulating unit, which is provided to regulate the pressure of the liquid which liquid is disposed in the hose, to a predetermined value.

6. The device according to claim 1, wherein the force is oriented parallel to the axial direction of the spherical roller bearing.

7. A wind turbine including a device according to claim 1.

8. A method for preloading, by exerting a force on at least one part of a bearing ring, using a device according to claim 1.

9. A device comprising:
at least one spherical roller bearing having at least one split outer ring comprising a first ring part and a second ring part;
an elastic tube operably connected to the first ring part;
a pump configured to pump a liquid into the tube; and
a controller configured to control the pump to change a pressure in the tube.

10. The device according to claim 9, wherein the controller is configured to maintain a given pressure in the tube.

11. The device according to claim 9, wherein the controller is configured to cause the pump to pump liquid into the tube and to pump liquid out of the tube to maintain a given pressure in the tube.

12. The device according to claim 9, wherein the tube is in direct contact with the first ring part.

13. A method for preloading a spherical roller bearing by exerting a force on a split outer ring of the spherical roller bearing using a device according claim 9.

14. A device comprising:
at least one spherical roller bearing having at least one split outer ring comprising a first ring part and a second ring part; and
means for maintaining a preload on the first ring part of the at least one split ring.

15. The device according to claim 14, wherein the means for maintaining a preload comprises an elastic tube operably connected to the first ring part and a pump configured to pump a liquid into the tube.

16. The device according to claim 15, wherein the means for maintaining a preload further comprises a controller for controlling the pump.

17. A method for preloading a spherical roller bearing by exerting a force on a split outer ring of the spherical roller bearing using a device according claim 13.
